(19) United States
(12) Patent Application Publication
(10) Pub. No.: US 2016/0335975 A1
(43) Pub. Date: Nov. 17, 2016

(54) Array Substrate and Driving Method Thereof, Display Panel, and Display Apparatus

(71) Applicants: BOE Technology Group Co., Ltd., Beijing (CN); Hefei Xinsheng Optoelectronics Technology Co., Ltd, Anhui (CN)

(72) Inventor: Rongcheng Liu, Beijing (CN)

(21) Appl. No.: 15/139,606

(22) Filed: Apr. 27, 2016

(30) Foreign Application Priority Data
May 12, 2015 (CN) 201510240077.0

(51) Int. Cl. G09G 3/36

(52) U.S. Cl. CPC G09G 3/3688; G09G 3/3696; G09G 3/3677; G09G 2330/021; G09G 2300/0814; G09G 2310/0278; G09G 2310/027

(57) ABSTRACT

Provided are an array substrate and driving method thereof, a display panel and a display apparatus. In the array substrate, at least one data line has at least one switch thereon. Each switch is configured to connect or disconnect two parts of the data line that are electrically connected to the switch respectively, and a control component is configured to, according to the positional relationship of a data driving circuit, a currently scanning gate line and each switch, control the switch to connect or disconnect. When applying a gate scanning signal to the gate line between the switch and the data driving circuit, the control component can control the switch to disconnect; when applying a gate scanning signal to the gate line on the side of the switch that is facing away from the data driving circuit, the control component can control the switch to connect.

This application claims priority to and the benefit of Chinese Patent Application No. 201510240077.0 filed on May 12, 2015, which application is incorporated herein in its entirety.

### TECHNICAL FIELD

The present disclosure relates to an array substrate and driving method thereof, a display panel, and a display apparatus.

### BACKGROUND

With continuous development of display technologies, flat panel displays such as LED (Light Emitting Diode), OLED (Organic Light Emitting Diode), PDP (Plasma Display Panel) and LCD (Liquid Crystal Display) are rapidly developing.

Taking the known LCD as an example, the known LCD comprises an array substrate, an opposite baseplate and a LC (Liquid Crystal) layer between the two baseplates, wherein gate lines, data lines, TFTs (Thin Film Transistors) and pixel electrodes are usually arranged on the side of the array substrate. When a gate driving circuit input a scanning signal of high level to a gate line, the TFTs connected with the gate line are in the turning-on state, and gray scale signals applied to data lines by a data driving circuit are applied to pixel electrodes through the TFTs.

### SUMMARY

At least one embodiment of the present disclosure provides an array substrate and driving method thereof, a display panel, and a display apparatus to reduce power consumption of the data driving circuit.

At least one embodiment of the present disclosure provides an array substrate comprising a substrate body, and multiple gate lines and multiple data lines that are crossing each other and insulated from each other on the substrate body, wherein the array substrate further comprises:

at least one switch located on at least one of the data lines, each of the at least one switch being configured to connect or disconnect two parts of a data line that are electrically connected to the switch respectively; and

a control component configured to, according to the positional relationship of a data driving circuit, a currently scanning gate line and each of the at least one switch, control the switch to be in a connecting state or a disconnecting state.

In a possible implementation, the above array substrate provided by at least one embodiment of the present disclosure further comprises at least one control line parallel to the gate lines, wherein

the switch is located at crossing positions of the control line and the data lines; and

the control component is configured to, according to the positional relationship of the data driving circuit, the currently scanning gate line and each of the at least one control line, control the switches located on the control line through the control line to be in the connecting state simultaneously or in the disconnecting state simultaneously.

In a possible implementation, the above array substrate provided by at least one embodiment of the present disclosure further comprises multiple pixel units arranged in matrix, wherein

the control line is located at spacing between two adjacent rows of the pixel units.

In a possible implementation, in the above array substrate provided by at least one embodiment of the present disclosure, the control line and the gate lines are arranged in the same layer.

In a possible implementation, in the above array substrate provided by at least one embodiment of the present disclosure, each of the at least one switch comprises a gate and an active layer which are insulated from each other, and a source and a drain electrically connected to the active layer respectively; and

the source and the drain in each of the at least one switch are respectively electrically connected to the two parts of the data line electrically connected to the switch, and the gate in each of the at least one switch is electrically connected to the control line controlling the switch to be in the connecting state or in the disconnecting state.

In a possible implementation, in the above array substrate provided by at least one embodiment of the present disclosure, each of the pixel units comprises a thin film transistor (TFT) and a pixel electrode; and

the gate in the switch and a gate in the TFT are arranged in the same layer, the active layer in the switch and an active layer in the TFT are arranged in the same layer, and the source and the drain in the switch and a source and a drain in the TFT are arranged in the same layer.

At least one embodiment of the present disclosure also provides a display panel comprising the above array substrate

At least one embodiment of the present disclosure also provides a display apparatus comprising the above display panel.

At least one embodiment of the present disclosure also provides a driving method for the above array substrate, comprising: a gate driving circuit applying gate scanning signals to the gate lines sequentially, and the data driving circuit applying gray scale signals to the data lines, wherein

for each of the at least one switch, when applying the gate scanning signal to the gate line between the switch and the data driving circuit, the control component controls the switch to be in the disconnecting state; and

for each of the at least one switch, when applying the gate scanning signal to the gate line on the side of the switch that is facing away from the data driving circuit, the control component controls the switch to be in the connecting state.

In a possible implementation, in the above method provided by at least one embodiment of the present disclosure, the array substrate further comprises at least one control line parallel to the gate lines; the switch is located at crossing positions of the control line and the data lines;

said for each of the at least one switch, when applying the gate scanning signal to the gate line between the switch and the data driving circuit, the control component controlling the switch to be in the disconnecting state comprises that:

when applying the gate scanning signal to the gate line between each of the at least one control line and the data driving circuit, the control component applies a first control signal to the control line to control the switches on the control line to be simultaneously in the disconnecting state; and

said for each of the at least one switch, when applying the gate scanning signal to the gate line on the side of the switch that is facing away from the data driving circuit, the control component controlling the switch to be in the connecting state comprises that:

when applying the gate scanning signal to the gate line on the side of each of the at least one control line that is facing away from the data driving circuit, the control component applies a second control signal to the control line to control the switches on the control line to be simultaneously in the connecting state.

In a possible implementation, in the above method provided by at least one embodiment of the present disclosure, each of the at least one switch comprises a gate and an active layer which are insulated from each other, and a source and a drain electrically connected to the active layer respectively; the source and the drain in each of the at least one switch are respectively electrically connected to the two parts of the data line electrically connected to the switch, and the gate in each of the at least one switch is electrically connected to the control line controlling the switch to be in the connecting state or in the disconnecting state;

said when applying the gate scanning signal to the gate line between each of the at least one control line and the data driving circuit, the control component applying a first control signal to the control line to control the switches on the control line to be simultaneously in the disconnecting state comprises that:

when applying the gate scanning signal to the gate line between each of the at least one control line and the data driving circuit, the control component applies a first voltage signal to the control line to control the switches on the control line to be simultaneously in the disconnecting state; and

said when applying the gate scanning signal to the gate line on the side of each of the at least one control line that is facing away from the data driving circuit, the control component applying a second control signal to the control line to control the switches on the control line to be simultaneously in the connecting state comprises that:

when applying the gate scanning signal to the gate line on the side of each of the at least one control line that is facing away from the data driving circuit, the control component applies a second voltage signal to the control line to control the switches on the control line to be simultaneously in the connecting state.

Embodiments of the present disclosure provide an array substrate and driving method thereof, a display panel and a display apparatus. In the array substrate, at least one data line has at least one switch thereon. Each switch is configured to connect or disconnect two parts of the data line that are electrically connected to the switch respectively, and the control component is configured to, according to the positional relationship of a data driving circuit, a currently scanning gate line and each switch, control the switch to be in a connecting state or a disconnecting state. In such a way, when applying a gate scanning signal to the gate line between the switch and the data driving circuit, the control component can control the switch to disconnect; when applying a gate scanning signal to the gate line on the side of the switch that is facing away from the data driving circuit, the control component can control the switch to connect. As such, the gray scale signal applied by the data driving circuit to a data line is not necessarily applied to the whole data line, and the gray scale signal applied to the data line only charges the coupling capacitance corresponding to part of the data line while charging the pixel electrode. Therefore, it is possible to reduce the power consumption of the data driving circuit.

### BRIEF DESCRIPTION OF THE DRAWINGS

FIG. 1 is a schematic diagram of structure of an array substrate provided by an embodiment of the present disclosure;

FIG. 2 is an equivalent circuit diagram of any data line in the array substrate shown in FIG. 1;

FIG. 3 is a schematic diagram of structure of another array substrate provided by an embodiment of the present disclosure;

FIG. 4 is a schematic diagram of structure of a switch in an array substrate provided in an embodiment of the present disclosure; and

FIG. 5 and FIG. 6 are driving time sequence diagrams corresponding to the array substrate shown in FIG. 3 respectively.

### DETAILED DESCRIPTION

In the following, detailed description is made on specific implementations of array substrates and driving methods thereof, display panels and display apparatuses provided by embodiments of the present disclosure in connection with the figures.

The shape and the size of each component in the figures do not reflect real scale of the array substrate, but only aim to schematically illustrate the content of the present disclosure.

In the above known technical solutions, the inventor(s) has/have noted that, due to that the gray scale signal applied by the data driving circuit to the data line would be applied to the whole data line, coupling capacitance would be formed between the whole data line and each gate line and between the whole data line and the LC layer, resulting in that the gray scale signal applied on the data line also charges the coupling capacitance corresponding to the whole data line while charging the pixel electrodes, such that the power consumption of the data driving circuit is large. Therefore, it is needed to reduce the power consumption of the data driving circuit.

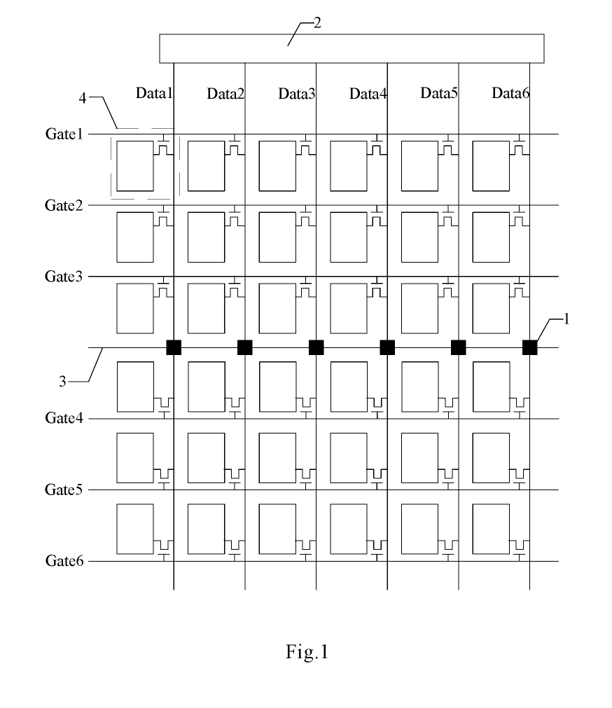

FIG. 1 is a schematic diagram of structure of an array substrate provided by an embodiment of the present disclosure. As shown in FIG. 1, the array substrate comprises a substrate body and multiple gate lines Gate1, Gate2 . . . , Gate6 and multiple data lines Data1, Data2 . . . , Data6 that are crossing each other and insulated from each other on the substrate body (FIG. 1 illustrates 6 gate lines and 6 data lines as an example).

The array substrate further comprises at least one switch 1 located on at least one of the data lines (FIG. 1 illustrates that one switch 1 is arranged on each data line as an example). Each switch 1 is configured to connect or disconnect two parts of the data line that are electrically connected to the switch 1 respectively.

The array substrate further comprises a control component. The control component is configured to, according to the positional relationship of a data driving circuit 2, a currently scanning gate line and each switch 1, control the switch 1 to be in a connecting state or a disconnecting state.

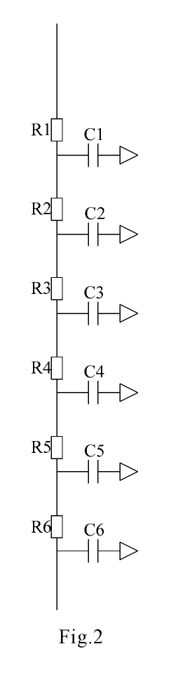

Description is made by taking that the data driving circuit 2 is located on the side near the gate line Gate1 as an example. As shown in FIG. 1, when applying gate scanning signals to the gate lines Gate1, Gate2 and Gate3 between the switches 1 and the data driving circuit 2, the control component can control the switches 1 to be in the disconnecting state. In such a way, the gray scale signals applied by the data driving circuit 2 to the data lines Data1, Data2, . . . , Data6 are not necessarily applied to the whole data lines, the gray scale signals applied to the data lines Data1, Data2 . . . , Data6 only charge the coupling capacitance (C1, C2 and C3 as shown in FIG. 2; FIG. 2 is an equivalent circuit corresponding to any data line in FIG. 1, wherein R1, R2 . . . , R6 are resistances of the data line respectively, and C1, C2 . . . , C6 are coupling capacitances between the data line and the gate lines or the LC layer respectively) corresponding to parts of the data line between the switches 1 and the data driving circuits 2 while charging the pixel electrodes electrically connected to the gate lines Gate1, Gate2 and Gate 3, such that it is possible to reduce the power consumption of the data driving circuit 2. When applying gate scanning signals to the gate lines Gate4, Gate5 and Gate6 on the side of the switches 1 that is facing away from the data driving circuit 2, the control component can control the switches 1 to be in the connecting state. In such a way, the gray scale signals applied by the data driving circuit 2 to the data lines Data1, Data2 . . . , Data6 can charge the pixel electrodes electrically connected to the gate lines Gate4, Gate5 and Gate6.

It is noted that, in the above array substrate provided by an embodiment of the present disclosure, the switch can be of any structure that is able to realize the connecting and disconnecting function to connect and disconnect the two parts of the data line electrically connected to the switch. For example, the switch can be a thin film transistor (TFT), and the control component can be a control chip that can apply a voltage signal to the TFT to control the turning on or turning off of the TFT. In addition, the number of switches arranged on the data lines is not limited to that each data line is provided with one switch as shown in FIG. 1. For example, one data line can be provided with one switch, or one data line can be provided with multiple switches, or one data line can be provided with no switch, which is not limited herein. Further, the arrangement of the switches on the data lines is not limited to the arrangement direction of the switches being parallel to the extension direction of the gate lines as shown in FIG. 1. For example, the switches arranged on the data lines can be arranged according to a certain rule, or the switches arranged on the data lines can be arranged randomly, which is limited herein.

In implementation, as shown in FIG. 1, the above array substrate provided by an embodiment of the present disclosure can further comprise at least one control line 3 parallel to the gate lines Gate1, Gate2 . . . , Gate6. The switches 1 are located at crossing positions of the control line 3 and the data lines Gate1, Gate2 . . . , Gate6. The control component is configured to, according to the positional relationship of the data driving circuit 2, the currently scanning gate line and each control line 3, control the switches 1 located on the control line 3 through the control line 3 to be in the connecting state simultaneously or in the disconnecting state simultaneously. FIG. 1 illustrates arranging one control line 3 as an example.

In implementation, as shown in FIG. 1, the above array substrate provided by an embodiment of the present disclosure can further comprise multiple pixel units 4 arranged in matrix. The material of the control line 3 can be transparent conducting material, e.g., ITO (Indium Tin Oxides), or the material of the control line 3 can also be nontransparent metal material, which is not limited herein. When the material of the control line 3 is nontransparent metal material, in order that the control line 3 does not to influence the aperture opening ratio of the array substrate, it is needed to arrange the control line 3 at spacing between two adjacent rows of pixel units 4.

Optionally, in the above array substrate provided by an embodiment of the present disclosure, if the material of the control line is nontransparent metal material and the control line is located at spacing between two adjacent rows of pixel units, the control line and the gate lines can be arranged in the same layer, that is, the control line and the gate lines are located in the same film layer, and they are of the same material. In such a way, compared with the known array substrate, the control line added in the above array substrate provided by an embodiment of the present disclosure would not increase manufacturing processes of the array substrate, and not increase the manufacturing cost of the array substrate.

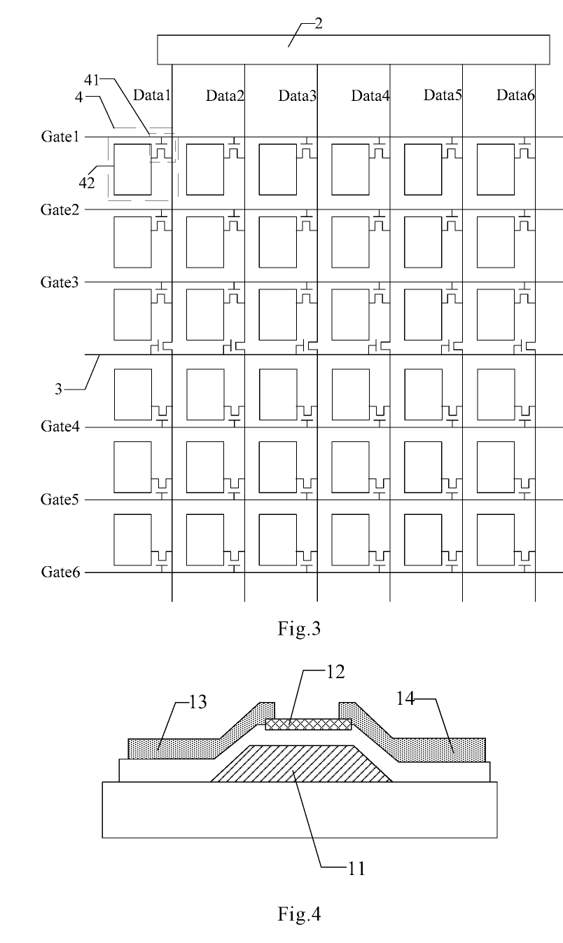

In implementation, in the above array substrate provided by an embodiment of the present disclosure, as shown in FIG. 3, the switch 1 can be a structure of TFT, which is similar to the structure of known TFTs. As shown in FIG. 4, the switch 1 can comprise a gate 11 and an active layer 12 which are insulated from each other, and a source 13 and a drain 14 electrically connected to the active layer respectively 12. As shown in FIG. 3, the source 13 and the drain 14 in each switch 1 are respectively electrically connected to the two parts of the data line electrically connected to the switch 1, and the gate 11 in each switch 1 is electrically connected to the control line 3 controlling the switch 1 to be in the connecting state or in the disconnecting state. In such a way, the control component can control the switches 1 on the control line 3 to be in the connecting state simultaneously or in the disconnecting state simultaneously by applying a time sequence signal to the control line 3.

In implementation, in the above array substrate provided by an embodiment of the present disclosure, as shown in FIG. 3, the switches can all be N type TFTs, or the switches can all be P type TFTs, which is not limited herein.

Of course, in the above array substrate provided by an embodiment of the present disclosure, the switches on the control line are not limited to the structure of the TFTs shown in FIG. 3, but can be another similar structure that can realize the connecting and disconnecting function through the control of the control line, which is not limited herein.

In implementation, in the above array substrate provided by an embodiment of the present disclosure, as shown in FIG. 3, each pixel unit 4 can comprise a TFT 41 and a pixel electrode 42. Since the switches 1 are also in a structure of TFT, the gate in the switch 1 and the gate in the TFT 41 can be arranged in the same layer, the active layer in the switch 1 and an active layer in the TFT 41 can be arranged in the same layer, and the source and the drain in the switch 1 and a source and a drain in the TFT 41 can be arranged in the same layer. In such a way, compared with the known array substrate, the switches added in the above array substrate provided by an embodiment of the present disclosure would not increase manufacturing processes of the array substrate, and not increase the manufacturing cost of the array substrate.

It is noted that, FIG. 3 is illustrated by an example that two adjacent gate lines and two adjacent data lines define one pixel unit and each pixel unit comprises one TFT and one pixel electrode, that is, the array substrate shown in FIG. 3 is applied to LCD. However, the above array substrate provided by an embodiment of the present disclosure can also be applied to flat display panels such as LED, OLED and PDP, which is not limited herein.

Based on the same inventive concept, an embodiment of the present disclosure also provides a display panel comprising the above array substrate provided by an embodiment of the present disclosure. The implementation of the display panel can refer to the embodiments of the above array substrate, which will not be repeated herein.

It is noted that the above display panel provided by an embodiment of the present disclosure can be any of LCD, LED, OLED and PDP, which is not limited herein.

Based on the same inventive concept, an embodiment of the present disclosure also provides a display apparatus comprising the above display panel provided by an embodiment of the present disclosure. The display apparatus can be any product or component with display function such as a cell phone, a pad computer, a television, a display, a notebook computer, a digital photo frame, a navigator or the like. The implementation of the display apparatus can refer to the embodiments of the above display panel, which will not be repeated herein.

With respect to the above array substrate provided by an embodiment of the present disclosure, an embodiment of the present disclosure also provides a driving method of an array substrate, comprising: a gate driving circuit applying gate scanning signals to the gate lines sequentially, and the data driving circuit applying gray scale signals to the data lines, wherein

for each switch, when applying the gate scanning signal to the gate line between the switch and the data driving circuit, the control component controls the switch to be in the disconnecting state; and

for each switch, when applying the gate scanning signal to the gate line on the side of the switch that is facing away from the data driving circuit, the control component controls the switch to be in the connecting state.

In implementation, in the above method provided by an embodiment of the present disclosure, when the array substrate is of the structure as shown in FIG. 3, the array substrate further comprises at least one control line 3 parallel to the gate lines; the switch is located at crossing positions of the control line 3 and the data lines.

Concerning the above mentioned step that for each switch, when applying the gate scanning signal to the gate line between the switch and the data driving circuit, the control component controls the switch to be in the disconnecting state, for example, it can be implemented in the following manner.

When applying the gate scanning signal to the gate line between each control line and the data driving circuit, the control component applies a first control signal to the control line to control the switches on the control line to be simultaneously in the disconnecting state.

Concerning the above mentioned step that for each switch, when applying the gate scanning signal to the gate line on the side of the switch that is facing away from the data driving circuit, the control component controls the switch to be in the connecting state, for example, it can be implemented in the following manner.

When applying the gate scanning signal to the gate line on the side of each control line that is facing away from the data driving circuit, the control component applies a second control signal to the control line to control the switches on the control line to be simultaneously in the connecting state.

In implementation, in the above method provided by an embodiment of the present disclosure, each switch can be of a structure of TFT, i.e., can comprise a gate and an active layer which are insulated from each other, and a source and a drain electrically connected to the active layer respectively. The source and the drain in each switch are respectively electrically connected to the two parts of the data line electrically connected to the switch, and the gate in each switch is electrically connected to the control line controlling the switch to be in the connecting state or in the disconnecting state. For example, the switches can all be N type TFTs, or the switches can all be P type TFTs, which is not limited herein.

Concerning the above mentioned step that when applying the gate scanning signal to the gate line between each control line and the data driving circuit, the control component applies a first control signal to the control line to control the switches on the control line to be simultaneously in the disconnecting state, for example, it can be implemented in the following manner.

When applying the gate scanning signal to the gate line between each control line and the data driving circuit, the control component applies a first voltage signal to the control line to control the switches on the control line to be simultaneously in the disconnecting state. For example, when the switches are all N type TFTs, the first voltage signal is a low level signal; when the switches are all P type TFTs, the first voltage signal is a high level signal.

Concerning the above mentioned step that when applying the gate scanning signal to the gate line on the side of each control line that is facing away from the data driving circuit, the control component applies a second control signal to the control line to control the switches on the control line to be simultaneously in the connecting state, for example, it can be implemented in the following manner.

When applying the gate scanning signal to the gate line on the side of each control line that is facing away from the data driving circuit, the control component applies a second voltage signal to the control line to control the switches on the control line to be simultaneously in the connecting state. For example, when the switches are all N type TFTs, the second voltage signal is a high level signal; when the switches are all P type TFTs, the second voltage signal is a low level signal.

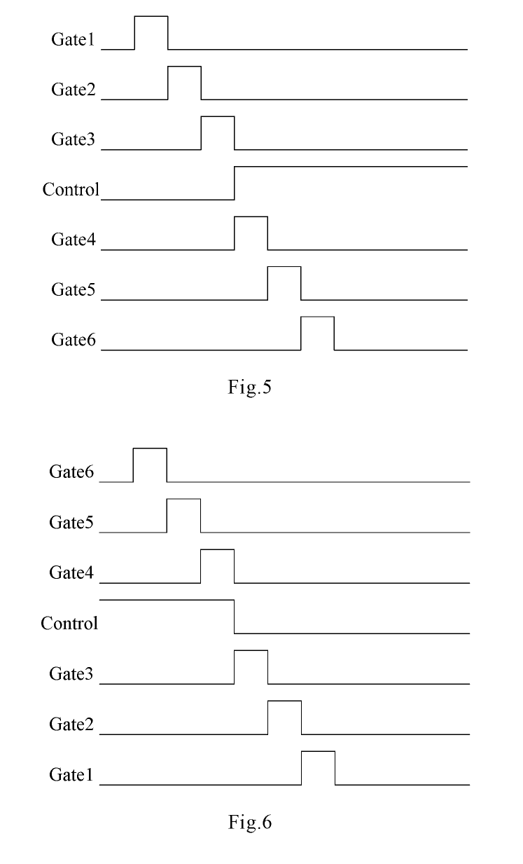

FIG. 5 is a driving time sequence diagram corresponding to the array substrate shown in FIG. 3. As shown in FIG. 5, the gate driving circuit scans the gate lines Gate1, Gate2 . . . , Gate6 in the sequence from Gate1 to Gate6. Before charging the pixel electrodes electrically connected to the gate line Gate4, the control component applies a control signal Control of low level to the control line to control the switches on the control line to be all in the disconnecting state, and the gray scale signals Data applied by the data driving circuit to the data lines Data1, Data2 . . . , Data6 charge the pixel electrodes electrically connected to the gate lines Gate1, Gate2 and Gate3, and charge the coupling capacitances C1, C2 and C3 simultaneously but do not charge the coupling capacitances C4, C5 and C6. When starting to charge the pixel electrodes electrically connected to the gate line Gate4, the control component applies a control signal Control of high level to the control line to control the switches on the control line to be all in the connecting state, and the gray scale signals Data applied by the data driving circuit to the data lines Data1, Data2 . . . , Data6 charge the pixel electrodes electrically connected to the gate lines Gate4, Gate5 and Gate6.

Of course, when the gate driving circuit applies gate scanning signals to the gate lines Gate 1, Gate2 . . . , Gate6 in sequence, the scanning can also be in the sequence from Gate6 to Gate1. The corresponding driving time sequence diagram is a driving time sequence diagram as show in FIG. 6, whose principle is the same as the principle of the driving time sequence diagram shown in FIG. 5, which will not be repeated herein.

Embodiments of the present disclosure provide an array substrate and driving method thereof, a display panel and a display apparatus. In the array substrate, at least one data line has at least one switch thereon. Each switch is configured to connect or disconnect two parts of the data line that are electrically connected to the switch respectively, and the control component is configured to, according to the positional relationship of a data driving circuit, a currently scanning gate line and each switch, control the switch to be in a connecting state or a disconnecting state. In such a way, when applying a gate scanning signal to the gate line between the switch and the data driving circuit, the control component can control the switch to disconnect; when applying a gate scanning signal to the gate line on the side of the switch that is facing away from the data driving circuit, the control component can control the switch to connect. As such, the gray scale signal applied by the data driving circuit to a data line is not necessarily applied to the whole data line, and the gray scale signal applied to the data line only charges the coupling capacitance corresponding to part of the data line while charging the pixel electrode. Therefore, it is possible to reduce the power consumption of the data driving circuit.

Obviously, those skilled in the art can make various modifications and variations on the present disclosure without departing from the spirit and scope of the present disclosure. If those modifications and variations fall in the scope of the claims of the present disclosure and equivalent thereof, the present disclosure intends to also include those modifications and variations.

What is claimed is:

1. An array substrate comprising a substrate body, and multiple gate lines and multiple data lines that are crossing each other and insulated from each other on the substrate body, wherein the array substrate further comprises:
at least one switch located on at least one of the data lines, each of the at least one switch being configured to connect or disconnect two parts of a data line that are electrically connected to the switch respectively; and
a control component configured to, according to the positional relationship of a data driving circuit, a currently scanning gate line and each of the at least one switch, control the switch to be in a connecting state or a disconnecting state.

2. The array substrate according to claim 1, further comprising at least one control line parallel to the gate lines, wherein
the switch is located at crossing positions of the control line and the data lines; and
the control component is configured to, according to the positional relationship of the data driving circuit, the currently scanning gate line and each of the at least one control line, control the switches located on the control line through the control line to be in the connecting state simultaneously or in the disconnecting state simultaneously.

3. The array substrate according to claim 2, further comprising multiple pixel units arranged in matrix, wherein
the control line is located at spacing between two adjacent rows of the pixel units.

4. The array substrate according to claim 2, wherein the control line and the gate lines are arranged in the same layer.

5. The array substrate according to claim 2, wherein each of the at least one switch comprises a gate and an active layer which are insulated from each other, and a source and a drain electrically connected to the active layer respectively; and
the source and the drain in each of the at least one switch are respectively electrically connected to the two parts of the data line electrically connected to the switch, and the gate in each of the at least one switch is electrically connected to the control line controlling the switch to be in the connecting state or in the disconnecting state.

6. The array substrate according to claim 5, wherein each of the pixel units comprises a thin film transistor (TFT) and a pixel electrode; and
the gate in the switch and a gate in the TFT are arranged in the same layer, the active layer in the switch and an active layer in the TFT are arranged in the same layer, and the source and the drain in the switch and a source and a drain in the TFT are arranged in the same layer.

7. A display panel comprising the array substrate according to claim 1.

8. A display apparatus comprising the display panel according to claim 7.

9. A driving method of the array substrate according to claim 1, comprising: a gate driving circuit applying gate scanning signals to the gate lines sequentially, and the data driving circuit applying gray scale signals to the data lines, wherein
for each of the at least one switch, when applying the gate scanning signal to the gate line between the switch and the data driving circuit, the control component controls the switch to be in the disconnecting state; and
for each of the at least one switch, when applying the gate scanning signal to the gate line on the side of the switch that is facing away from the data driving circuit, the control component controls the switch to be in the connecting state.

10. The method according to claim 9, wherein the array substrate further comprises at least one control line parallel to the gate lines; the switch is located at crossing positions of the control line and the data lines;
said for each of the at least one switch, when applying the gate scanning signal to the gate line between the switch and the data driving circuit, the control component controlling the switch to be in the disconnecting state comprises that:
when applying the gate scanning signal to the gate line between each of the at least one control line and the data driving circuit, the control component applies a first control signal to the control line to control the switches on the control line to be simultaneously in the disconnecting state; and
said for each of the at least one switch, when applying the gate scanning signal to the gate line on the side of the switch that is facing away from the data driving circuit, the control component controlling the switch to be in the connecting state comprises that:
when applying the gate scanning signal to the gate line on the side of each of the at least one control line that is facing away from the data driving circuit, the control component applies a second control signal to the control line to control the switches on the control line to be simultaneously in the connecting state.

11. The method according to claim 10, wherein each of the at least one switch comprises a gate and an active layer which are insulated from each other, and a source and a drain electrically connected to the active layer respectively; the source and the drain in each of the at least one switch are respectively electrically connected to the two parts of the data line electrically connected to the switch, and the gate in each of the at least one switch is electrically connected to the control line controlling the switch to be in the connecting state or in the disconnecting state;
said when applying the gate scanning signal to the gate line between each of the at least one control line and the data driving circuit, the control component applying a first control signal to the control line to control the switches on the control line to be simultaneously in the disconnecting state comprises that:
when applying the gate scanning signal to the gate line between each of the at least one control line and the data driving circuit, the control component applies a first voltage signal to the control line to control the switches on the control line to be simultaneously in the disconnecting state; and
said when applying the gate scanning signal to the gate line on the side of each of the at least one control line that is facing away from the data driving circuit, the control component applying a second control signal to the control line to control the switches on the control line to be simultaneously in the connecting state comprises that:
when applying the gate scanning signal to the gate line on the side of each of the at least one control line that is facing away from the data driving circuit, the control component applies a second voltage signal to the control line to control the switches on the control line to be simultaneously in the connecting state.

12. The array substrate according to claim 3, wherein the control line and the gate lines are arranged in the same layer.

13. The array substrate according to claim 3, wherein each of the at least one switch comprises a gate and an active layer which are insulated from each other, and a source and a drain electrically connected to the active layer respectively; and
the source and the drain in each of the at least one switch are respectively electrically connected to the two parts of the data line electrically connected to the switch, and the gate in each of the at least one switch is electrically connected to the control line controlling the switch to be in the connecting state or in the disconnecting state.

14. The array substrate according to claim 4, wherein each of the at least one switch comprises a gate and an active layer which are insulated from each other, and a source and a drain electrically connected to the active layer respectively; and
the source and the drain in each of the at least one switch are respectively electrically connected to the two parts of the data line electrically connected to the switch, and the gate in each of the at least one switch is electrically connected to the control line controlling the switch to be in the connecting state or in the disconnecting state.

15. The array substrate according to claim 13, wherein each of the pixel units comprises a thin film transistor (TFT) and a pixel electrode; and
the gate in the switch and a gate in the TFT are arranged in the same layer, the active layer in the switch and an active layer in the TFT are arranged in the same layer, and the source and the drain in the switch and a source and a drain in the TFT are arranged in the same layer.

16. The array substrate according to claim 14, wherein each of the pixel units comprises a thin film transistor (TFT) and a pixel electrode; and
the gate in the switch and a gate in the TFT are arranged in the same layer, the active layer in the switch and an active layer in the TFT are arranged in the same layer, and the source and the drain in the switch and a source and a drain in the TFT are arranged in the same layer.

17. The display panel according to claim 7, wherein the array substrate further comprises at least one control line parallel to the gate lines;
the switch is located at crossing positions of the control line and the data lines;
the control component is configured to, according to the positional relationship of the data driving circuit, the currently scanning gate line and each of the at least one control line, control the switches located on the control line through the control line to be in the connecting state simultaneously or in the disconnecting state simultaneously.

18. The display panel according to claim 17, wherein the array substrate further comprises multiple pixel units arranged in matrix; and
the control line is located at spacing between two adjacent rows of the pixel units.

19. The display panel according to claim 17, wherein the control line and the gate lines are arranged in the same layer.

20. The display panel according to claim 17, wherein each of the at least one switch comprises a gate and an active layer which are insulated from each other, and a source and a drain electrically connected to the active layer respectively; and
the source and the drain in each of the at least one switch are respectively electrically connected to the two parts of the data line electrically connected to the switch, and the gate in each of the at least one switch is electrically connected to the control line controlling the switch to be in the connecting state or in the disconnecting state.
